(19) United States
(12) Patent Application Publication
(10) Pub. No.: US 2018/0229573 A1
(43) Pub. Date: Aug. 16, 2018

(54) Chassis Arrangement, Method For Levelling A Motor Vehicle, Control Device And Motor Vehicle

(71) Applicant: ZF FRIEDRICHSHAFEN AG, Friedrichshafen (DE)

(72) Inventor: Andreas FÖRSTER, Schweinfurt (DE)

(21) Appl. No.: 15/752,200

(22) PCT Filed: Jul. 11, 2016
(86) PCT No.: PCT/EP2016/066376

§ 371 Date: Feb. 12, 2018

(30) Foreign Application Priority Data
Aug. 13, 2015 (DE) 10 2015 215 508.0

(51) Int. Cl. B60G 17/06; B60G 21/055

(52) U.S. Cl. CPC B60G 17/06; B60G 17/0164; B60G 21/0551

(57) ABSTRACT

A chassis arrangement and method for leveling a vehicle with at least one vibration damper permitting an active height adjustment. The chassis arrangement has a stabilizer having a restoring force that rises with a first slope during a transverse acceleration in a first range up to a first threshold value and has a restoring force which rises with a second slope after the first threshold value in a second range. The second slope is greater than the first slope.

### CROSS REFERENCE TO RELATED APPLICATIONS

This is a U.S. national stage of application No. PCT/EP2016/066376, filed on Jul. 11, 2016. Priority is claimed on German Application No. DE102015215508.0, filed Aug. 13, 2015, the content of which is incorporated here by reference.

### BACKGROUND OF THE INVENTION

### 1. Field of the Invention

The invention is directed to a chassis arrangement with at least one vibration damper providing active height adjustment.

### 2. Description of the Prior Art

The height adjustment of a motor vehicle can serve a number of purposes. For one, it can be used for compensation of rolling and pitching, wherein accelerating maneuvers or braking maneuvers are reacted to. These are movements of the motor vehicle body that occur within rather short periods of time. Further, it is known to carry out a level adjustment, for example, based on a load condition of the motor vehicle. This is a height adjustment that is to be carried out over an entire trip. Further, a height adjustment can also be carried out in driving situations that occur in the intervening time period between the situations described above, namely, for example, during prolonged cornering.

Moreover, it is known to use height-adjustable vibration dampers to compensate for road irregularities. For these kinds of demands, camera systems are also often used so that there is no delay between the occurrence of an irregularity and the reaction of the chassis or the height adjustment of the vibration damper.

Accordingly, it is known to carry out the height adjustment of a motor vehicle by the vibration damper depending on the axles, the sides or even separately for individual vibration dampers.

Vibration dampers that are capable of performing in this way usually have a pump by which the hydraulic medium is moveable in the vibration damper so that the height position of the vibration damper or the position of the piston and, therefore, of the piston rod is variable. Vibration dampers of this kind are disclosed, for example, in US 2009/0260935 A1, DE 10 2009 022 328 A1 or WO 2014/066469 A1. In this instance, the body control, i.e., the intended influencing of the height position of the vehicle body, or the wheel control, i.e., the adjustment of the damping force of the vibration damper, can be carried out.

### SUMMARY OF THE INVENTION

In chassis arrangements with active vibration dampers, there is the problem that the amount of energy available for operation is limited. The vibration dampers must be supplied via the on-board power supply of the motor vehicle, the power of this on-board power supply being limited by the available energy of a battery.

Therefore, it is an object of one aspect of the present application to provide a chassis arrangement that can be operated with a lower expenditure of energy. In order to solve this problem, it is proposed that the chassis arrangement have a stabilizer that has a restoring force that rises with an, on average, first slope during a transverse acceleration in a first range up to a first threshold value and has a restoring force that rises with an, on average, second slope from the first threshold value in a second range, where the second slope is greater than the first slope.

When energy consumption by active vibration dampers is analyzed, it turns out that a portion of the energy is used first to compensate for effects of a stabilizer and only then to achieve the required height adjustment. Therefore, it is now provided to use a stabilizer having a low restoring force up to a first threshold value and a greater restoring force from a second threshold value. The first range accordingly extends from 0 to the first threshold value. Accordingly, in a matter of speaking, when driving in a straight line the compensation of road irregularities and the compensation of rolling and pitching movements is the concern of the vibration damper, while, for example, during prolonged cornering, the stabilizer takes over the adjustment of forces. In this way, an energy-optimized system is achieved overall in which the vibration damper or vibration dampers need no longer work against the stabilizer but, on the contrary, are relieved by the stabilizer in large energy intensity ranges.

The first threshold value can advantageously be in a range of from 3 m/s² to 5 m/s², in particular 4 m/s². Analyses have shown that the best possible relief of the vibration dampers without tolerating loss of comfort is achieved when the threshold value is selected in this range.

Advantageously, the restoring force can be less than 10 N in the first range. In particular, the restoring force can be equal to 0 either within the entire range or at least within a portion thereof. As has been described, it may happen in the first range that the vibration damper works against the stabilizer. Therefore, it is desirable that its restoring force is as small as possible in the first range; that is, the first slope can also be equal to zero in its entirety.

In the second range, the rise in restoring force can advantageously have a substantially parabolic curve at least partially. Accordingly, when there is a slight increase in transverse acceleration, a disproportionate increase in the restoring force can be achieved. Consequently, it is possible that after a predeterminable transverse acceleration the stabilizer applies the restoring force, and does so with a known characteristic.

At least one coupling rod of the stabilizer can preferably have a cylindrical housing and a piston which is axially moveable therein. The piston has a freewheeling in the central region, and a stop is provided for the piston at the respective ends of the freewheeling. A coupling bar constructed in this manner realizes a restoring force of 0, or close to 0, in a range up to a first transverse acceleration. After the stop, via which the first threshold value can be determined, the interplay of the piston and stop ensures the presence of restoring force.

The stop can advantageously be configured to be elastic. Accordingly, the stop is not necessarily a rigid stop but rather offers resistance against the movement of the piston. Therefore, the stop can be implemented in many different ways. For example, the stop may be constructed as a rigid body having a rubber or other elastic compound at its end facing the piston. However, the stop can also be formed in its entirety from a rubber or other elastic material. Alternatively, the stop can also be formed as a spring, particularly a helical spring.

Also, as a result of the stop, a movement of the piston in direction of the end of the coupling rod is made increasingly difficult with increasing distance from the center of the coupling rod toward the end. The piston can preferably be preloaded against at least one end by a spring. As a result of the preloading, the piston has a preferred position in the center of the coupling rod that does not continually contact a stop. When a spring is used, the stabilizer also has restoring forces below the first threshold value, although these restoring forces are negligible compared to the second range. In this case, the spring for preloading is not the stop spring in case the stop is constructed as a spring.

At least one stop can preferably have a recess for receiving a spring; that is, the spring extends through the stop and can accordingly be supported at the end of the coupling rod.

The coupling rod can advantageously have a piston rod connected to the piston for connecting the stabilizer to a chassis element of a motor vehicle. Further, the coupling rod can have a piston rod guide so that the piston rod is fixed at two points.

One aspect of the invention is further directed to a method for leveling a motor vehicle with at least one vibration damper permitting an active height adjustment and with a stabilizer. The method is characterized in that during a transverse acceleration in a first range up to a first threshold value a greater restoring force is transmitted to the vehicle body by the at least one vibration damper than by the stabilizer and after the first threshold value a greater restoring force is transmitted to the vehicle body by the stabilizer than by the at least one vibration damper, and at least the restoring forces transmitted by the stabilizer in the first range differ from those transmitted by the stabilizer in the second range. To prevent unnecessary repetition, the chassis arrangement that has already been described is referred to generally. This chassis arrangement allows the method to be implemented as has been described.

The restoring force which can be introduced into the at least one vibration damper via an adjusting device can preferably be greater in the first range than in the second range. Advantageously, the stabilizer can transmit an increasing restoring force in the second range from the first threshold value to a second threshold value and can transmit a constant restoring force in a third range from the second threshold value.

Alternatively, it is also conceivable that the stabilizer transmits a mean restoring force with a second slope in the second range from the first threshold value to the second threshold value and transmits a restoring force with a third slope in the third range from the second threshold value, where the second slope is greater than the third slope. Accordingly, there can be a first range, second range and third range, where the mean slope is greatest in the second range.

In addition, the invention is directed to a control device for carrying out the method as has been described.

The invention is further directed to a motor vehicle with a chassis arrangement and a control device. This motor vehicle is characterized in that the chassis arrangement is configured as was described and/or the control device is configured as was described. The motor vehicle is preferably a road vehicle, in particular a passenger vehicle, a commercial vehicle, or a motorcycle.

### BRIEF DESCRIPTION OF THE DRAWINGS

Further advantages, features and details of the invention are indicated in the following description of embodiment examples and figures. The drawings show:

FIG. 1 is a motor vehicle;

FIG. 2 is a coupling rod;

FIG. 3 is a characteristic line;

FIG. 4 is a stabilizer with coupling rods in a second embodiment; and

FIG. 5 is a coupling rod in cross section.

### DETAILED DESCRIPTION OF THE PRESENTLY PREFERRED EMBODIMENTS

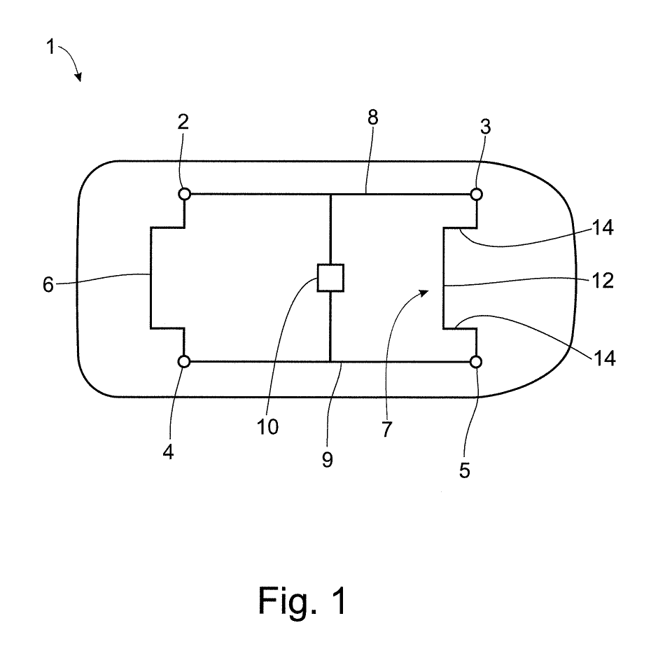

FIG. 1 shows a motor vehicle 1 with vibration dampers 2, 3, 4, and 5 and two stabilizers 6 and 7. The vibration dampers 2, 3, 4, and 5 are actively adjustable with respect to height, i.e., they can be used for body control. The vibration dampers 2, 3, 4, and 5 are connected to a control device 10 via lines 8 and 9. The stabilizers 6 and 7 are not connected to the control device 10 because they are purely mechanical.

The stabilizers are constructed in two parts, and they comprise a crossbar 12 and two coupling rods 14.

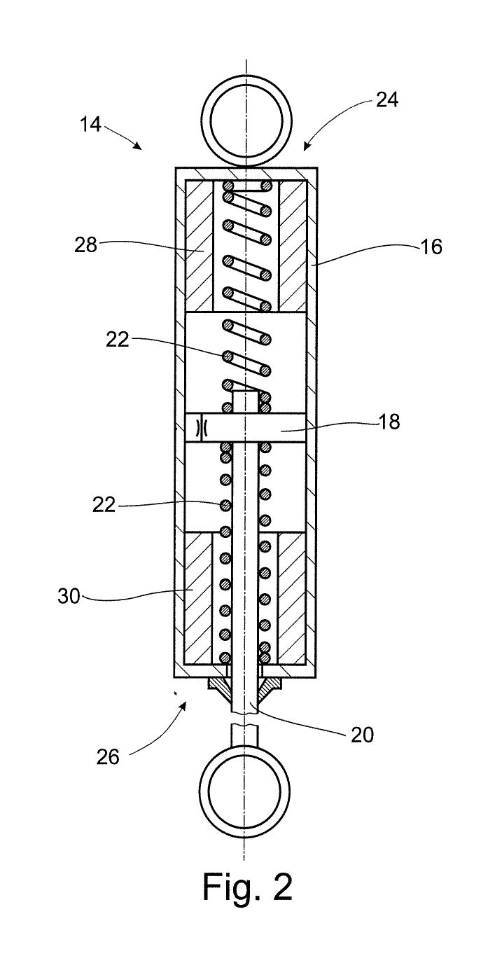

One of the coupling rods 14 is shown in detail in FIG. 2.

FIG. 2 shows a coupling rod 14 comprising a tubular element 16 and a piston 18 that is axially moveable therein. A piston rod 20 is fastened to the piston 18. The piston 18 is supported relative to the housing by two springs 22 such that it has a basic or preferred position in the center of the tubular element 16. Otherwise, the piston 18 is freely moveable in the central area of the coupling rod 14, i.e., it is freewheeling in the central area.

Stop 28 and 30, respectively, are located at the two ends 24 and 26 of the tubular element 16.

The stops 28 and 30 can be constructed to be elastic. They can also have a rigid area and a kind of elastic layer or cap, for example, in the form of a rubber ring facing the piston. In principle, however, the ring can also be arranged on the housing side.

Alternatively, the stops can be constructed as stiff helical springs, for example.

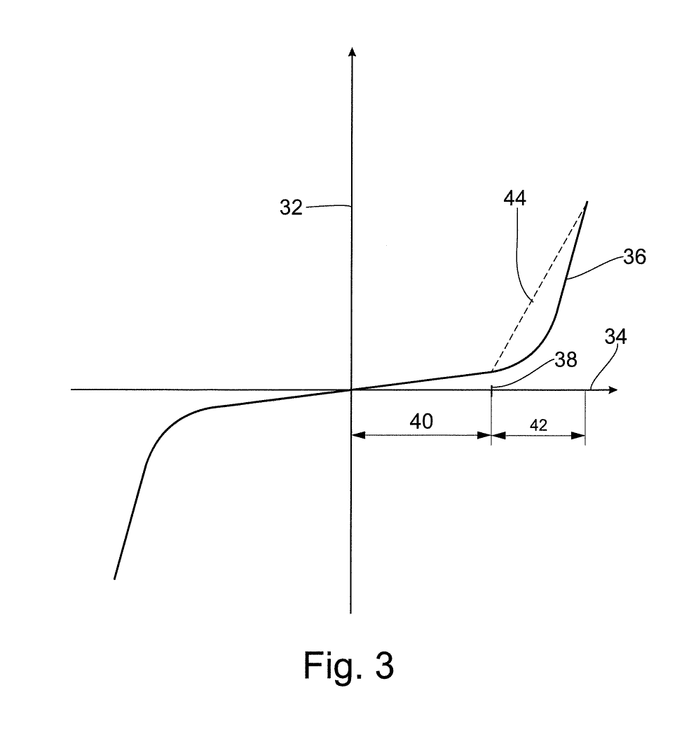

FIG. 3 shows a characteristic line of a stabilizer with variable supporting force, for example, a stabilizer 6 with two coupling rods 14.

The resulting restoring force of the stabilizer is plotted on axis 32 and the deflection value is plotted on axis 34. Path, deflection angle or transverse acceleration can be plotted. At a first threshold value 38 in a first range 40 between 0 and the first threshold value 38, the resulting characteristic line 36 is close to 0 and has a small mean slope. However, in the second range 42 starting from the first threshold value 38, the mean slope 44 of the characteristic line 36 is much greater than the mean slope in the first range 40. In the first range 40, the slope is linear, which is why the mean slope in this range coincides with characteristic line 36. In the second range 42, the slope of the characteristic line is parabolic, which is why the restoring force increases disproportionately compared with the path or angle.

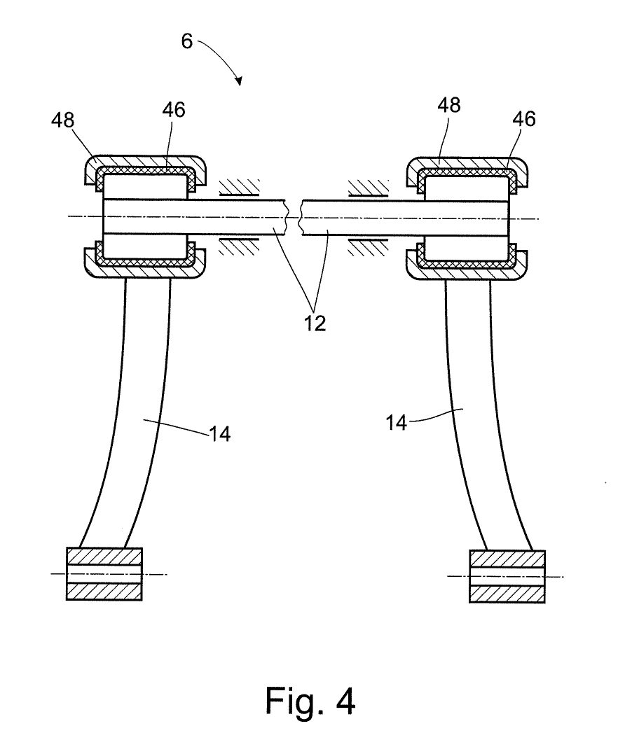

FIG. 4 shows a second embodiment of a coupling rod 14 for implementing a nonlinear stabilizer 6. In this case, at the ends of the crossbar 12 of the stabilizer 6 there are two stops 46 connected to the crossbar 12 so as to be fixed with respect to rotation relative to it. The coupling rods 14 are connected to the crossbars in each instance via a ring joint 48.

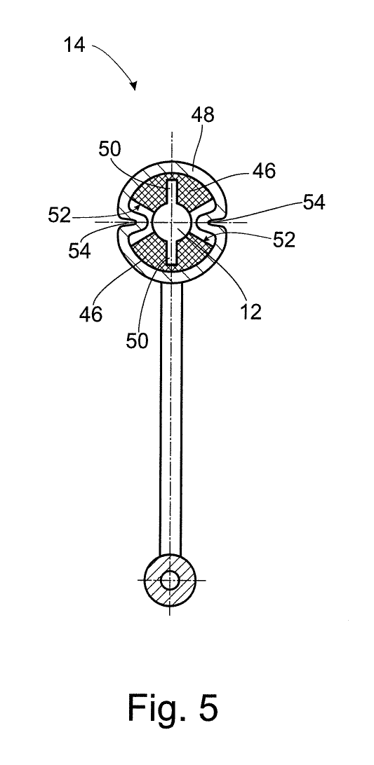

The interaction of the stops 46 and ring joints 48 will be discerned from FIG. 5. The stops 46 are connected by a plate 50 to the crossbar 12 so as to be fixed with respect to rotation relative to it. It can be seen in cross section that there is a free space between the stop faces 52 taking up approximately one third in circumferential direction.

The indentations 54 can be formed through a beading of a ring joint 50 cooperate with the stop faces 52.

The stops 46 can be constructed to be elastic. In particular, they can be made of rubber.

The indentations 54, as stops of the coupling rod 14, have freewheeling relative to the stop faces 52 of the stops 46, and the coupling rod 14 and crossbar 12 are connected with respect to force only after a predefinable angle has been covered.

1.-20. (canceled)

21. A chassis arrangement comprising:
at least one vibration damper providing active height adjustment; and
a stabilizer that has a first restoring force that rises with, on average, a first slope during a transverse acceleration in a first range up to a first threshold value and a second restoring force that rises with, on average, a second slope from the first threshold value in a second range,
wherein the second slope is greater than the first slope.

22. The chassis arrangement according to claim 21, wherein the first threshold value is in a range of from 3 m/s² to 5 m/s².

23. The chassis arrangement according to claim 21, wherein the first restoring force in the first range is at least one of:
less than 10 N and 0.

24. The chassis arrangement according to claim 21, wherein the rise in the second restoring force in the second range is at least partially a substantially parabolic curve.

25. The chassis arrangement according to claim 21, wherein the stabilizer further comprises:
at least one coupling rod having:
a cylindrical housing;
a piston that is axially moveable in the cylindrical housing, wherein the piston has freewheeling in a central region; and,
a stop is provided for the piston at the respective ends of the freewheeling.

26. The chassis arrangement according to claim 25, wherein the stop is configured to be elastic.

27. The chassis arrangement according to claim 26, wherein the piston is preloaded against at least one end by a spring.

28. The chassis arrangement according to claim 27, wherein at least one stop has a recess for receiving the spring.

29. The chassis arrangement according to claim 25, wherein the coupling rod has a piston rod connected to the piston to connect the stabilizer to a chassis element of a motor vehicle.

30. The chassis arrangement according to claim 21, wherein the stabilizer has at least one stop connected to a crossbar so as to be fixed with respect to rotation relative to it, wherein a coupling rod is rotatable relative to the stop.

31. The chassis arrangement according to claim 30, wherein the coupling rod has a ring joint for coupling to the crossbar.

32. The chassis arrangement according to claim 31, wherein a contour that cooperates with the at least one stop and allows a freewheeling is provided at the ring joint.

33. The chassis arrangement according to claim 31, wherein two indentations cooperating with the at least one stop are provided in axial direction at the ring joint.

34. The chassis arrangement according to claim 30, wherein the at least one stop is connected to the crossbar by at least one plate.

35. A method for leveling a motor vehicle having at least one vibration damper configured to permit an active height adjustment and at least one stabilizer, comprising:
transmitting, during a transverse acceleration in a first range up to a first threshold value, a greater restoring force to a vehicle body by the at least one vibration damper than by the at least one stabilizer; and
transmitting in a second range from the first threshold value a greater restoring force to the vehicle body by the at least one stabilizer than by the at least one vibration damper,
wherein at least the restoring forces transmitted by the at least one stabilizer in the first range differ from those in the second range.

36. The method according to claim 35, wherein the restoring force introduced into the at least one vibration damper via an adjusting device is greater in the first range than in the second range.

37. The method according to claim 36, wherein the at least one stabilizer transmits no force in the first range.

38. The method according to claim 37, wherein the at least one stabilizer transmits an increasing restoring force in the second range from the first threshold value to a second threshold value and transmits a constant restoring force in a third range from the second threshold value.

39. A control device for a motor vehicle, wherein the control device is configured to:
transmit, during a transverse acceleration in a first range up to a first threshold value, a greater restoring force to a vehicle body by at least one vibration damper than by at least one stabilizer; and
transmit in a second range from the first threshold value a greater restoring force to the vehicle body by the at least one stabilizer than by the at least one vibration damper,
wherein at least the restoring forces transmitted by the at least one stabilizer in the first range differ from those in the second range.

40. A motor vehicle comprising:
a chassis arrangement comprising:
at least one vibration damper providing active height adjustment; and
a stabilizer that has a restoring force that rises with, on average, a first slope during a transverse acceleration in a first range up to a first threshold value and a restoring force that rises with, on average, a second slope from the first threshold value in a second range,
wherein the second slope is greater than the first slope; and
a control device, wherein the control device is configured to:
transmit, during the transverse acceleration in the first range up to the first threshold value, a greater restoring force to a vehicle body by the at least one vibration damper than by the at least one stabilizer; and
transmit in the second range from the first threshold value a greater restoring force to the vehicle body by the at least one stabilizer than by the at least one vibration damper,
wherein at least the restoring forces transmitted by the at least one stabilizer in the first range differ from those in the second range.
